(19) United States
(12) Patent Application Publication
(10) Pub. No.: US 2016/0021861 A1
(43) Pub. Date: Jan. 28, 2016

(54) FISHING CADDY SYSTEM AND METHOD

(71) Applicant: Live Holdings LLC, Olathe, KS (US)

(72) Inventor: Joseph M. Pippins, Olathe, KS (US)

(21) Appl. No.: 14/808,931

(22) Filed: Jul. 24, 2015

Related U.S. Application Data
(60) Provisional application No. 62/028,626, filed on Jul. 24, 2014.
(60) Provisional application No. 62/065,549, filed on Oct. 17, 2014.

(51) Int. Cl. A01K 97/06; A01K 97/04; A01K 99/00; A01K 97/10

(52) U.S. Cl. CPC A01K 97/06; A01K 97/10; A01K 97/04; A01K 99/00

(57) ABSTRACT

A fully-integrated fishing caddy system which generally includes a five gallon bucket as a base and a padded lid enclosing the interior of the bucket, the padded lid further serving as a seat for the user. The bucket includes at least one rod holder which can be rotated to different angles to suit the user. There are hooks in the bucket for receiving the fishing line and thereby preventing the wind from blowing the line around, resulting in faster detection of catches. Other features include the ability to place caught fish into the bucket via a chute, cup holders, and drainage spouts.

### CROSS-REFERENCE TO RELATED APPLICATIONS

This application claims priority in U.S. Provisional Patent Application No. 62/028,626, filed on Jul. 24, 2014, and also claims priority in U.S. Provisional Patent Application No. 62/065,549, filed Oct. 17, 2014, both of which are incorporated herein by reference.

### BACKGROUND OF THE INVENTION

1. Field of the Invention

The present invention relates generally to a fishing caddy, and particularly to a unique caddy with adjustable features for accommodating various species and fishing environments.

2. Description of the Related Art

Currently a person going fishing has to pack a number of items, including a folding chair, hooks, rods, rod holders, and flashlights or head lamps. The fisherman would have to carry all of this gear to and from the fishing site, as well as set the gear up on the site once they have reached the site.

Existing rod holders require the holders to be driven into the solid earth, resulting in rods being placed too far from the water and resulting in missed bites. These holders are also non-adjustable and cannot be placed in locations without soil present. Existing rod holders are further subject to missed catches on windy days when it is difficult to tell when a catch is on the line.

Head lamps and flashlights are added costs which can scare fish away when shone directly into the water. Light is necessary when fishing early in the morning, but can be detrimental if the fish are scared away from the source.

Heretofore there has not been available a fishing caddy system and method with the advantages and features of the disclosed subject matter.

### SUMMARY OF THE INVENTION

A fully-integrated fishing caddy system which generally includes a five gallon bucket as a base and a padded lid enclosing the interior of the bucket, the padded lid further serving as a seat for the user. The bucket includes at least one rod holder which can be rotated to different angles to suit the user. There are hooks in the bucket for receiving the fishing line and thereby preventing the wind from blowing the line around, resulting in faster detection of catches. Other features include the ability to place caught fish into the bucket via a chute, cup holders, and drainage spouts.

An alternative embodiment includes a rod holder unit which can be attached to an existing five gallon bucket or the like. The rod holder unit could be screwed into the bucket, using a backing plate placed within the bucket to receive the screws, or the rod holder could be punched through the wall of the bucket with spikes or screws, allowing a quick attachment to the bucket.

### BRIEF DESCRIPTION OF THE DRAWINGS

The drawings constitute a part of this specification and include exemplary embodiments of the invention illustrating various objects and features thereof, wherein like references are generally numbered alike in the several views.

FIG. 1 is an isometric drawing of a preferred embodiment of the present invention.

FIG. 2 is another isometric drawing thereof, showing a preferred embodiment of the present invention with its lid removed.

FIG. 3 is an isometric drawing of the lid thereof.

FIG. 4 is a front elevational view of the preferred embodiment of the present invention.

FIG. 5 is an isometric drawing of an alternative embodiment of the present invention.

FIG. 6 is another isometric drawing thereof.

FIG. 6A is a detailed isometric diagram taken about the circle of FIG. 6.

FIG. 6B is a continuation of FIG. 6A, showing the rod holder being pulled away from the base.

FIG. 6C is a continuation of FIG. 6B, showing the rod holder being rotated within the base.

FIG. 6D is a continuation of FIG. 6C, showing the tab of the rod holder being fitted into a different notch of the base.

FIG. 7 is a sectional view taken about line 7 of FIG. 6.

FIG. 8 is an isometric drawing of yet another alternative embodiment of the present invention.

FIG. 9 is another isometric drawing thereof.

### DETAILED DESCRIPTION OF THE PREFERRED EMBODIMENT

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning

The present invention is a fishing caddy system with various features and functions for accommodating different fishing conditions, target species and environments. For example and without limitation, the following description provides information concerning embodiments of the invention, which can be adapted and changed as necessary.

II. Preferred embodiment fishing caddy system 2

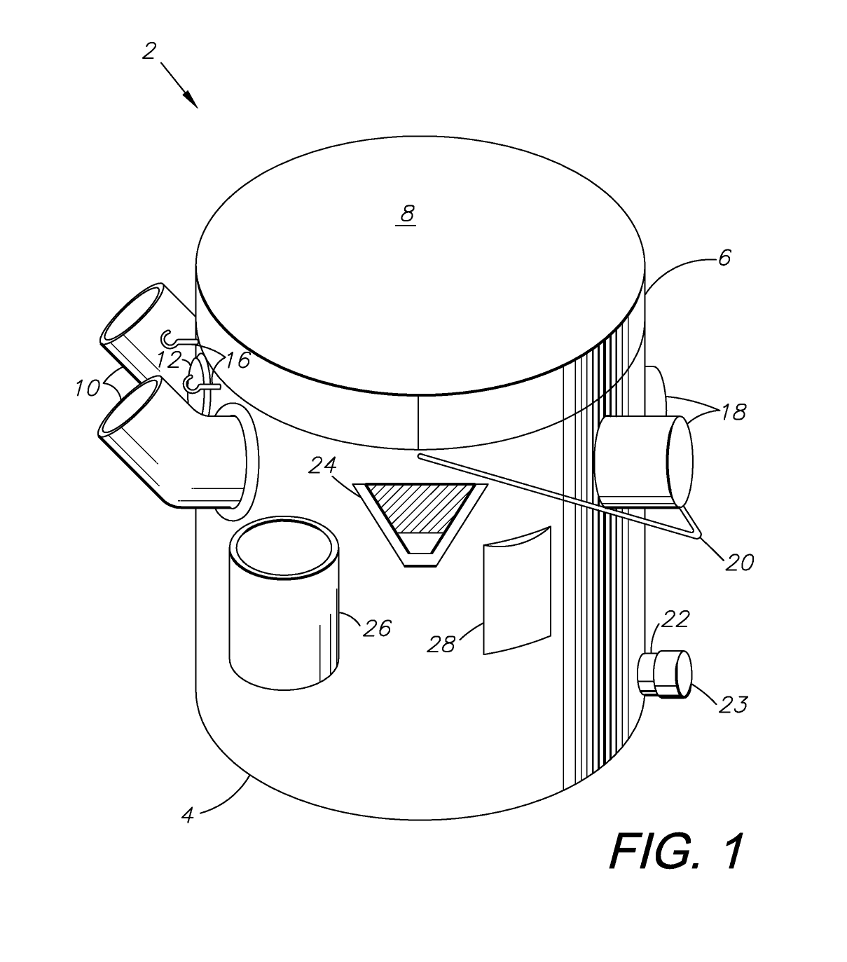

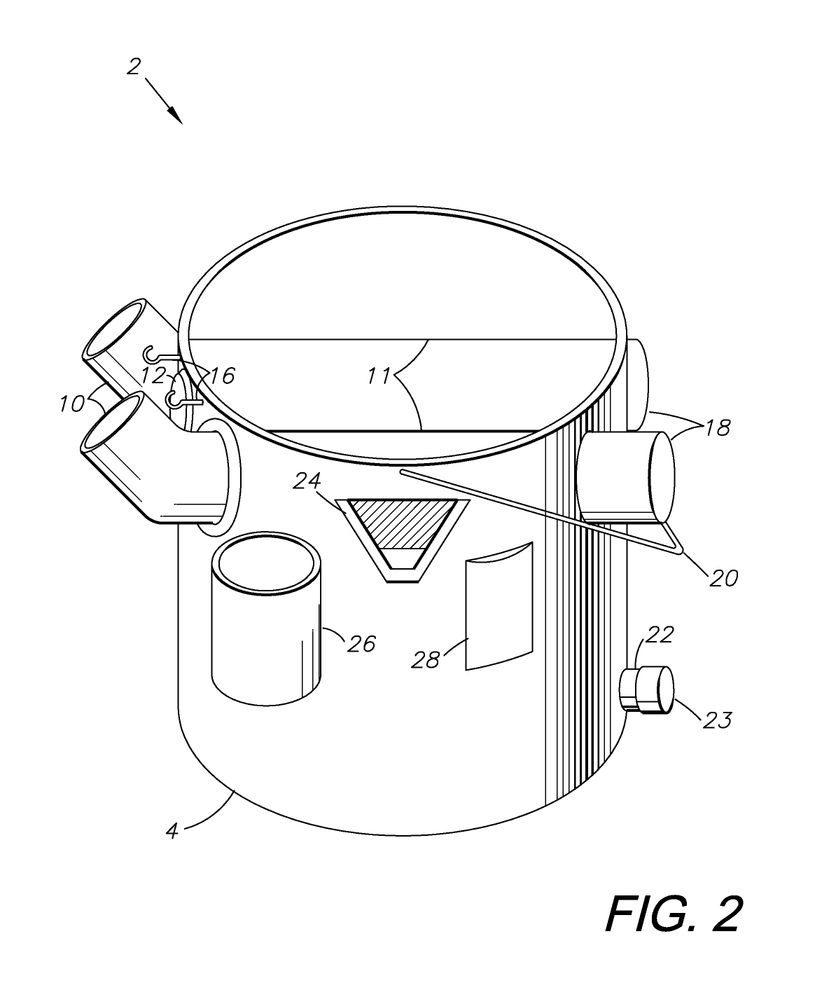

As shown in FIGS. 1 and 2, the fishing caddy system 2 is a device that allows a fisherman to sit while monitoring his or her poles 30. This device comprises a plastic bucket 4 that has four holes in it which allows piping 11 to go through one side to the other. This piping has a handle 18 on the back side which allows the fisherman to adjust the height and angle of his or her rod which his placed within a rod holder 10 located on the other end of the piping 11 from the handles 18. The device has a cushion 8 on the lid 6 which allows for more comfort when sitting for longer periods of time.

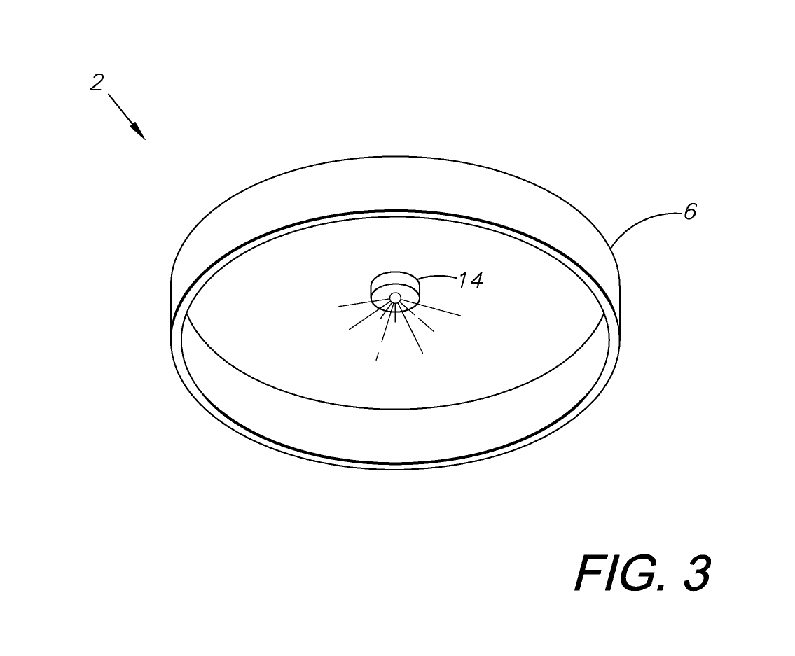

In the middle of the device is a light emitting diode (LED) receiver 12 for an LED light 14 that allows the fisherman to see his or her lines at night and also fishing tackle in low light conditions. The bucket itself may also illuminate or be illuminated by mounting an LED light 14 underneath of the bucket lid 6 as shown in FIG. 3. In this setup, the actual bucket will glow a faint light since the plastic of the bucket is not perfectly opaque. This lighting system may be powered by either solar or battery power.

The cushion 8 may be attached to the lid by a hook and loop fastener system so that the cushion may be washed when it is dirty. The “lip” of the lid has small holes in it that will allow the fisherman to anchor down the fishing caddy when it is not being sat upon. The caddy can also be attached to the earth below through the use of metal “U” poles. In a preferred embodiment, however, the bucket is simply filled with water prior to placing the lid 6 onto the bucket 4, and this water holds the bucket down.

The device allows the fisherman to select special notches in which to place his or her rod depending on the species of fish which is sought to be caught. Examples include: a 35 degree angle for catching trout or other fish which require less line visibility 90 degree angle for catching fish which are light biters to enable quicker fishing rod reaction time, or a 180 degree, vertical angle for fish species which are heavy bitters and line tuggers.

The fishing caddy device will be highly personalizable and available in various color choices. The included piping will also be available in a wide variety of colors and styles. Fishing tackle boxes will be able to be attached to the side of the fishing caddy device through notches above the marked water line on the caddy. Additional lighting may also be attached.

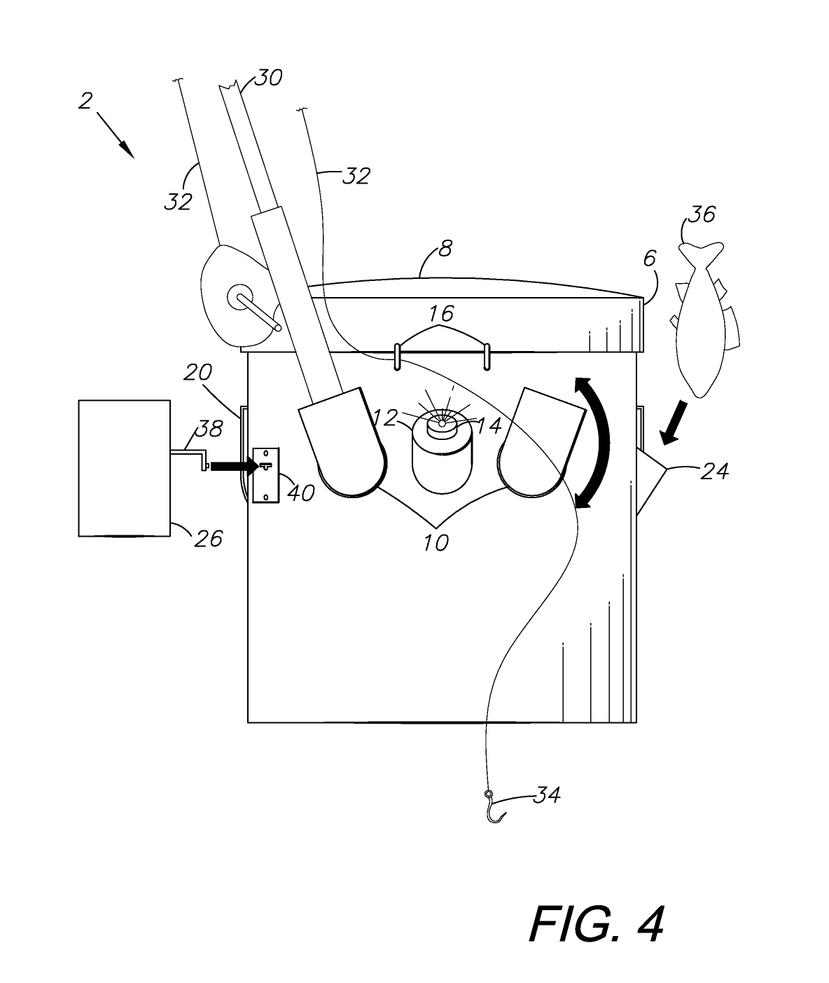

Referring back to FIG. 1, the bucket 4 includes a handle 20 which allows for easy transport of the system 2, both to and from the fishing site. A spout 22 with a cap 23 allows the water to be drained from the bucket once the user is done fishing for the day. A hook 16 is associated with each rod holder 10. These hooks receive the fishing line 32 of a fishing rod 30 connected to a fishing hook 34 as shown in FIG. 4, thereby preventing wind from blowing the line around, resulting in missed catches.

A fish chute 24 allows fish 36 to be placed into the bucket 4 when they are caught for easy storage. The chute may be attached to the bucket at a later stage, but essentially allows fish to easily slide into a hole in the bucket for storage.

A cup holder 26 and pouch 28 allow for additional storage and usability of the system 2. The cup holder 26 may be detachable, and may hang from a strap suspended around the rim of the bucket 4, or may include a connector arm 38 which connects to a receiver 40 mounted on the side of the bucket 4 as shown in FIG. 4. The pouch 28 may be waterproof and allows the user to store items, such as phones or wallets, with the system 2.

### III. Alternative Embodiment Fishing Caddy System 52

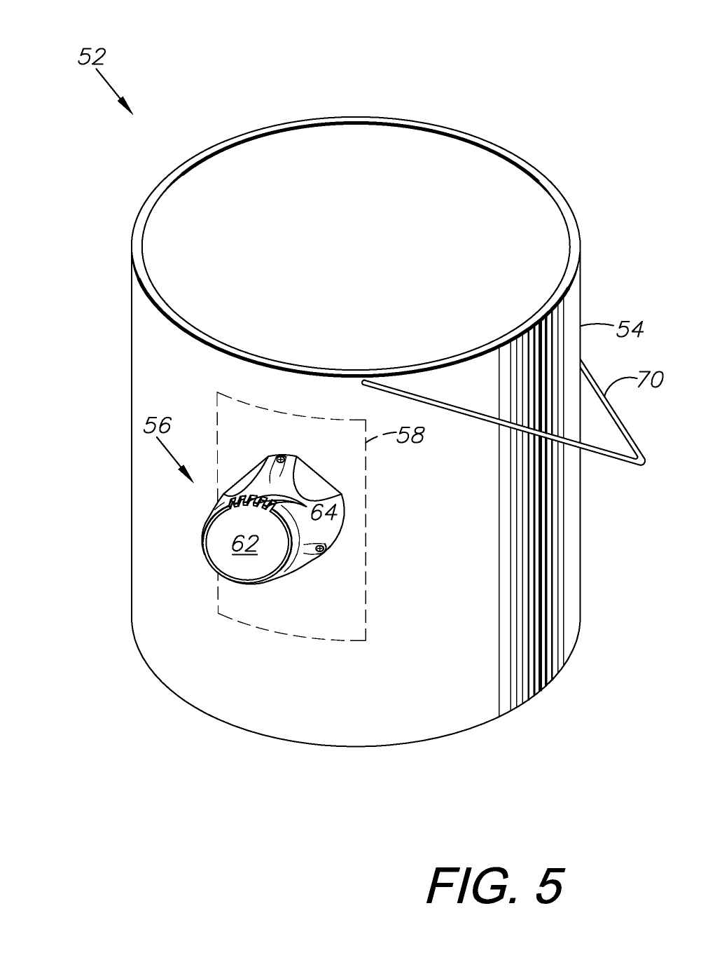

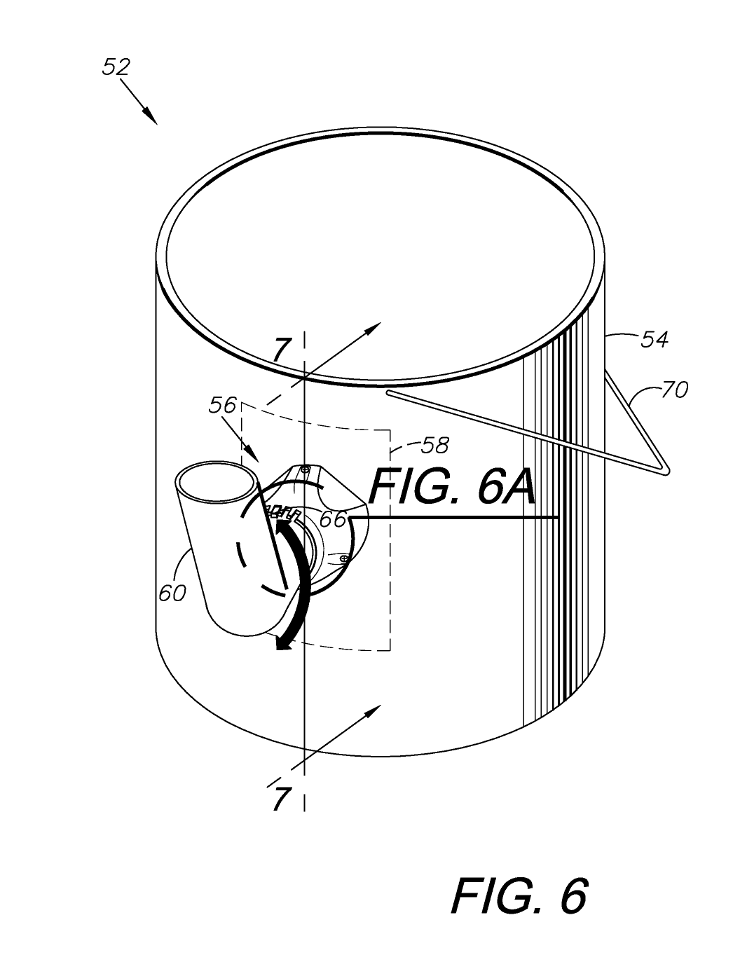

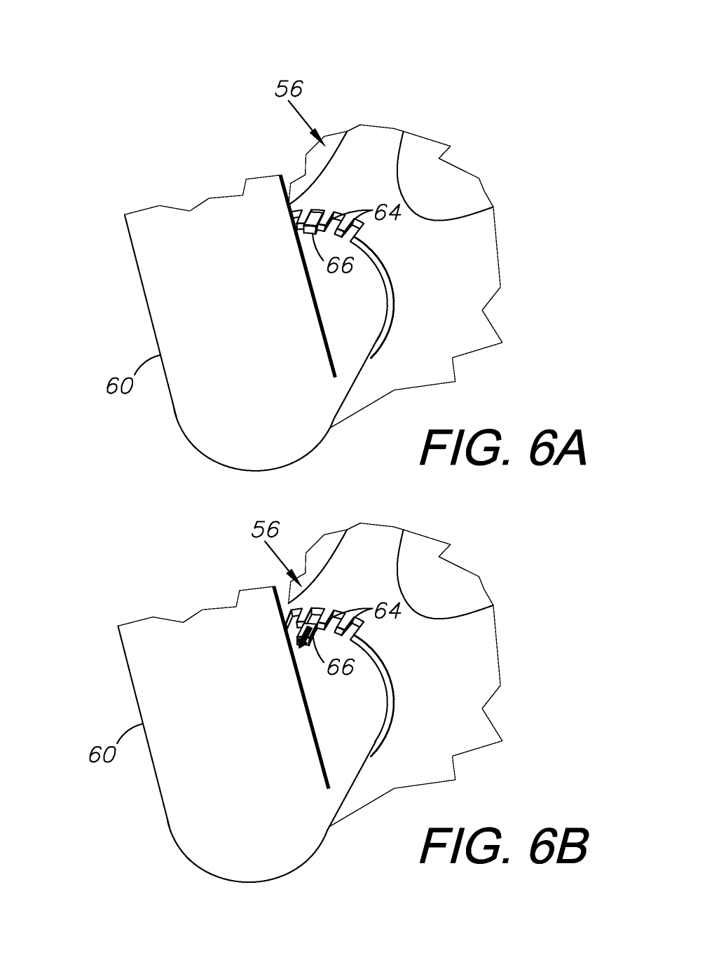

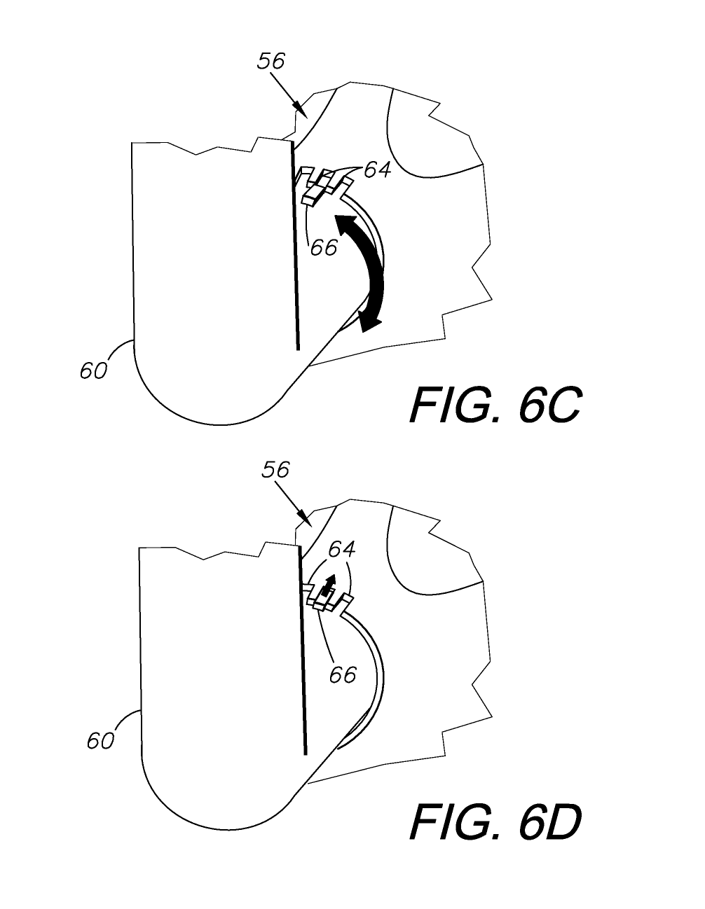

FIGS. 5 and 6 show an alternative fishing caddy system 52 which includes an existing bucket 54 which might have a handle 70. A rod holder base 56 is mounted to the exterior wall of the bucket 54 using screws or other attachment devices (e.g. strong adhesive, hook and loop fasteners, etc.). The embodiment showed uses screws which pass through the wall of the bucket 54 and are received by a backing plate 58 which is inserted into the inside of the bucket. The rod holder base 56 includes a receiver 62 for a rod holder 60 which slots into the base 56. A number of rotation notches 64 on the base 56 receive a tab 66 located on the end of the rod holder 60. This allows the rod holder 60 to be turned similar to the embodiment disclosed above.

FIGS. 6A-6D show how the rod holder 60 is rotated within the base 56 by pulling the rod holder away from the base (FIG. 6B), rotating the rod holder within the base (FIG. 6C), and reinserting the tab 66 of the rod holder 60 into another rotation notch 64 of the base 58 (FIG. 6D).

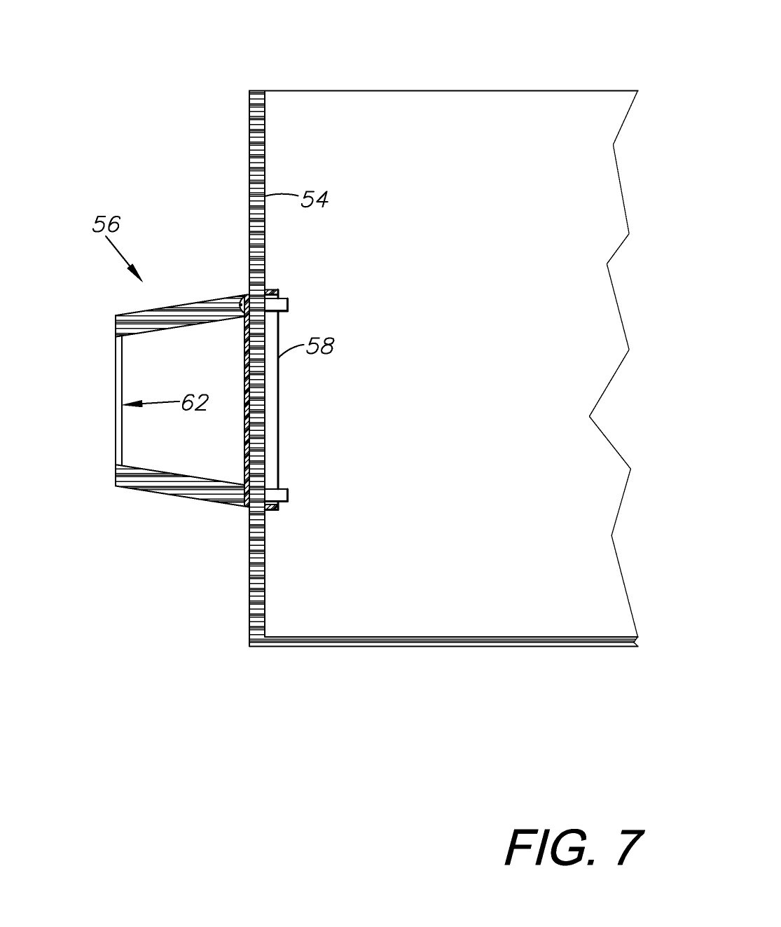

FIG. 7 shows a sectional view as taken about the line on FIG. 6. This view shows a better view of how the base 56 is screwed into the bucket 54 sidewall and into a backing plate 58 which receives the screws and holds the base in place.

Alternatively, the entire assembly could include multiple rod holders 60 connected to a single base assembly having multiple base connectors 56, and at least one LED mount placed in proximity to those base connectors, similar to the embodiment disclosed previously. In this way, a single attachment can include multiple rod holder elements in a single installable piece.

### IV. Alternative Embodiment Fishing Caddy System 102

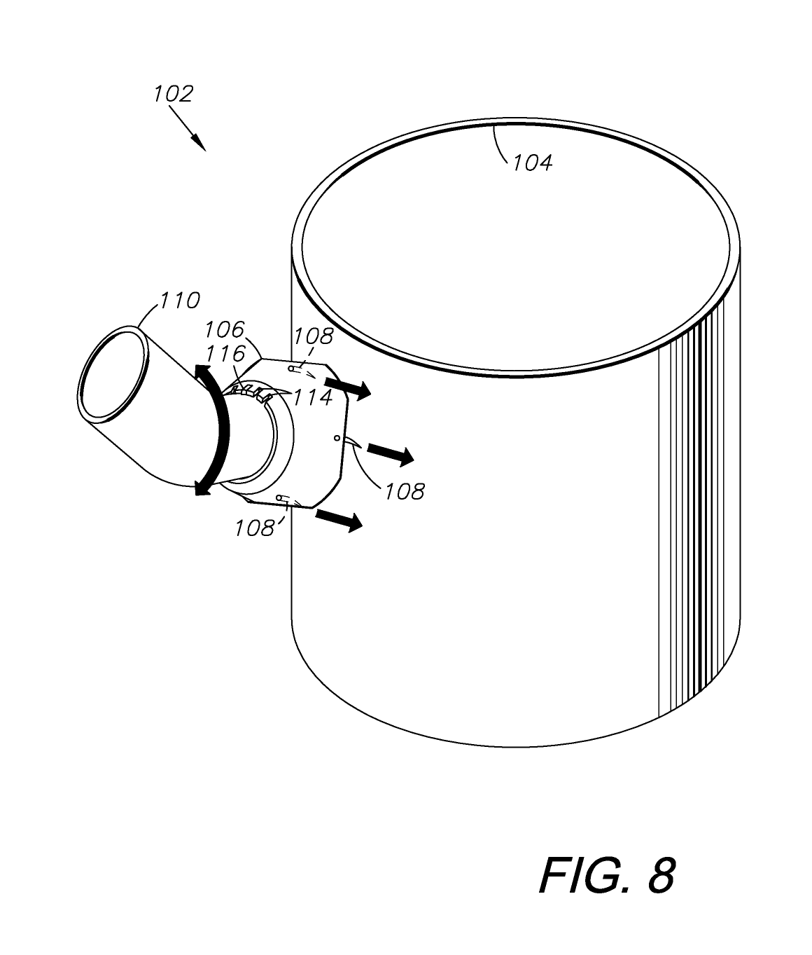

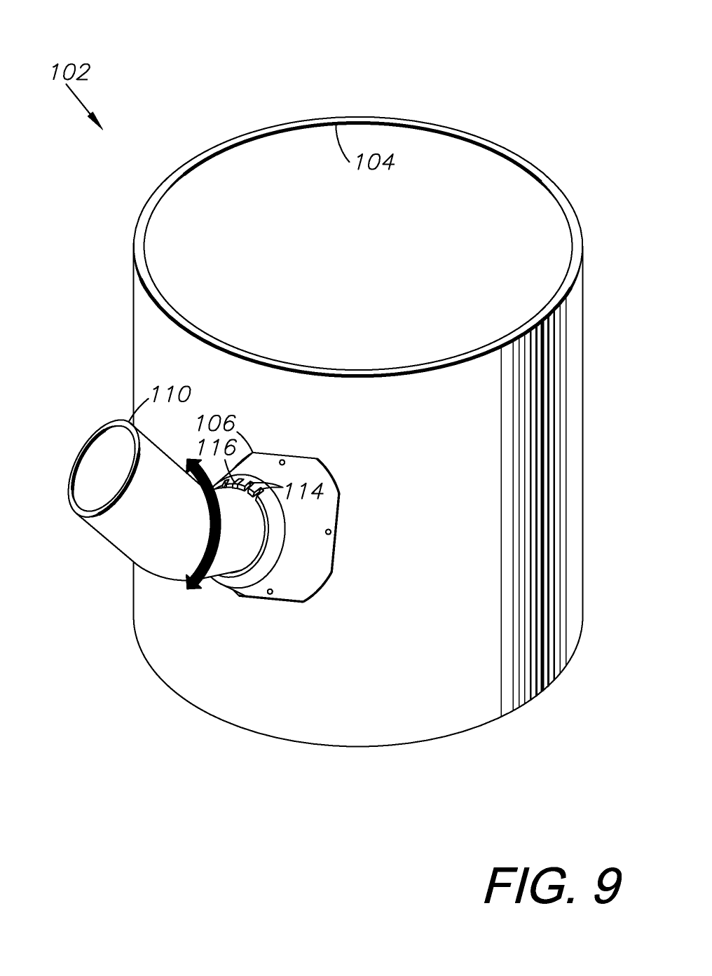

FIGS. 8 and 9 show another alternative fishing caddy system 102 which includes an existing bucket 104. This embodiment is somewhat similar to the alternative embodiment above. It features a rod holder base 106 which has several piercing elements 108, such as screws, which allow the system 102 to be pushed through the material of the bucket 104, creating a semi-permanent attachment to the bucket. Adhesives could also be used to supplement or replace the piercing elements 108.

A rod receiver 110 again is rotatable within the base 106 using a tab 116 of the rod receiver 110 which is slotted into one of multiple rotation notches 114 of the base 106.

The embodiments disclosed herein could include buckets of any size, not simply five gallon buckets as mentioned by example. These buckets could be of any material or color, as to associate with the use of LED lights used either on the interior or exterior of the buckets.

It is to be understood that while certain aspects of the disclosed subject matter have been shown and described, the disclosed subject matter is not limited thereto and encompasses various other embodiments and aspects.

Having thus described the disclosed subject matter, what is claimed as new and desired to be secured by Letters Patent is:

1. A fishing caddy system comprising:
a bucket having an open top, a closed base, and a wall having an interior face surrounding an interior space, and an exterior face;
a lid configured to cover said open top, said lid including a cushioned top face;
at least one rod holder connected to said bucket, said rod holder being rotatable about an axis running perpendicular to said bucket;
at least one hook affixed to said bucket in proximity to said at least one rod holder, said hook configured to receive a fishing line from a fishing rod placed within said at least one rod holder; and
a light emitting diode (LED) lamp receiver configured to receive an LED lamp.

2. The system of claim 1, further comprising:
said LED lamp receiver being located on an underside of said lid; and
said bucket comprising a semi-translucent material which allows light from said LED lamp to partially shine through said bucket.

3. The system of claim 1, wherein said LED lamp receiver is located on said bucket exterior face in proximity with said at least one rod holder.

4. The system of claim 1, further comprising:
a spout providing an opening from said interior face to said exterior face of said bucket, said spout allowing liquid within said bucket to be drained;
said spout being placed in proximity with said closed base of said bucket; and
a cap for temporarily sealing said spout.

5. The system of claim 1, further comprising:
a fish chute including an opening from said interior face to said exterior face of said bucket; and
said fish chute configured to receive fish, whereby said fish are stored within the interior of said bucket.

6. The system of claim 1, further comprising:
a pipe connecting said at least one rod holder to a corresponding handle located on the opposite side of said bucket;
said pipe running through the interior space of said bucket; and
wherein said pipe transfers rotation of said handle to said at least one rod holder, thereby rotating said rod holder.

7. The system of claim 1, further comprising a cup holder assembly, said cup holder assembly configured to receive a drink container.

8. The system of claim 7, further comprising:
a cup holder receiver connected to said exterior face of said bucket; and
said cup holder having a connector arm configured to temporarily attach to said bucket via said cup holder receiver.

9. The system of claim 1, further comprising:
a pouch affixed to said exterior face of said bucket, said pouch configured to receive personal accessories of the user.

10. The system of claim 9, wherein said pouch is water proof.

11. The system of claim 1, further comprising:
said at least one rod holder connected to a rod holder base;
said rod holder including a tab;
said base including a plurality of rotation slots; and
said tab configured to interface with one of said plurality of slots.

12. The system of claim 11, further comprising:
a backing plate placed on the interior face of said bucket in proximity with said rod holder base; and
a plurality of connecting elements connecting said rod holder base to said backing plate through said bucket.

13. The system of claim 11, further comprising:
a plurality of connecting elements located on said base;
said plurality of connecting elements configured to pierce the wall of said bucket through said exterior face to said interior face; and
whereby said plurality of connecting elements semi-permanently affix said base to said exterior face of said bucket.

14. A fishing caddy comprising:
a bucket having an open top, a closed base, and a wall having an interior face surrounding an interior space, and an exterior face;
a rod holder assembly configured to interface with said bucket, such that said rod holder assembly is semi-permanently affixed to said bucket;
said rod holder assembly comprising at least one rod holder configured to receive the handle of a fishing rod; and
said rod holder assembly further comprising a light emitting diode (LED) lamp receiver configured to receive an LED lamp.

15. The fishing caddy of claim 14, further comprising:
said rod holder assembly having two of said rod holders, each of said two rod holders located on opposite sides of said LED lamp receiver.

16. The system of claim 14, further comprising:
said at least one rod holder connected to a rod holder base;
said rod holder including a tab;
said base including a plurality of rotation slots; and
said tab configured to interface with one of said plurality of slots.

17. The system of claim 16, further comprising:
a backing plate placed on the interior face of said bucket in proximity with said rod holder base; and
a plurality of connecting elements connecting said rod holder base to said backing plate through said bucket.

18. The system of claim 16, further comprising:
a plurality of connecting elements located on said base;
said plurality of connecting elements configured to pierce the wall of said bucket through said exterior face to said interior face; and
whereby said plurality of connecting elements semi-permanently affix said base to said exterior face of said bucket.
